(19) United States
(12) Patent Application Publication
(10) Pub. No.: US 2025/0006109 A1
(43) Pub. Date: Jan. 2, 2025

(54) PIXEL AND DISPLAY DEVICE INCLUDING THE SAME

(71) Applicant: Samsung Display Co., Ltd., Yongin-Si (KR)

(72) Inventors: Jin Joo HA, Yongin-si (KR); Se Hyun LEE, Yongin-si (KR); Kwi Hyun KIM, Yongin-si (KR)

(21) Appl. No.: 18/625,199

(22) Filed: Apr. 3, 2024

(30) Foreign Application Priority Data
Jun. 28, 2023 (KR) 10-2023-0083758

(51) Int. Cl. G09G 3/32

(52) U.S. Cl. CPC G09G 3/32; G09G 2300/0426; G09G 2310/0267; G09G 2310/0275

(57) ABSTRACT

A pixel may include: a first transistor including a first electrode electrically connected to a first power line configured to receive first driving power, a second electrode, and a gate electrode connected to a first node; a second transistor connected between a data line and the first node, and including a gate electrode electrically connected to a first scan line; a light emitting element including a first electrode connected to the second electrode of the first transistor, and a second electrode electrically connected to a second power line configured to receive second driving power; a first capacitor connected between the first node and the first electrode of the light emitting element; and a second capacitor connected between the first electrode of the light emitting element and a third power line.

### CROSS-REFERENCE TO RELATED APPLICATION

The present application claims priority to Korean patent application number 10-2023-0083758 filed on Jun. 28, 2023, the entire disclosure of which is incorporated herein by reference.

### BACKGROUND

### Field of Invention

Various embodiments of the present disclosure relate to a pixel and a display device including the pixel.

### Description of Related Art

With the development of information technology, the importance of a display device, which is a connection medium between a user and information, has been emphasized. Owing to the importance of display devices, the use of various kinds of display devices, such as a liquid crystal display device and an organic light-emitting display device, has increased.

Recently, there has been development in head mounted display devices (HMDs). Head mounted display devices (HMDs) are display devices, which allow a user to wear in the form of glasses or a helmet, and are used to create virtual reality (VR) or augmented reality (AR) experiences where the focus is formed at a close distance in front of the eyes of the user. Head mounted display devices employ high-resolution panels, requiring pixels that can be applied to high-resolution panels.

### SUMMARY

Various embodiments of the present disclosure are directed to a pixel and a display device including the pixel, which can be applied to a high-resolution panel.

An embodiment of the present disclosure may provide a pixel including: a first transistor including a first electrode electrically connected to a first power line configured to receive first driving power, a second electrode, and a gate electrode connected to a first node; a second transistor connected between a data line and the first node, and including a gate electrode electrically connected to a first scan line; a light emitting element including a first electrode connected to the second electrode of the first transistor, and a second electrode electrically connected to a second power line configured to receive second driving power; a first capacitor connected between the first node and the first electrode of the light emitting element; and a second capacitor connected between the first electrode of the light emitting element and a third power line.

In an embodiment, a ratio of a capacitance of the second capacitor to a capacitance of the first capacitor may be at least 0.1.

In an embodiment, the second driving power may be a voltage lower than the first driving power.

In an embodiment, the third power line may receive first initialization power having a voltage value at which the light emitting element is turned off in response to receiving the first initialization power at the first electrode of the light emitting element.

In an embodiment, the first initialization power may be ground power.

In an embodiment, the pixel may further include: a third transistor connected between the first electrode of the light emitting element and the third power line, and including a gate electrode electrically connected to a second scan line; a third capacitor including a first electrode, and a second electrode connected to the first node; and a fourth transistor including a first electrode electrically connected to a fourth power line, a second electrode connected to the first electrode of the third capacitor, and a gate electrode electrically connected to a third scan line.

In an embodiment, each of the first, second, third, and fourth transistors may include a metal-oxide-semiconductor field-effect transistor (MOSFET) including a body electrode.

In an embodiment, the first driving power may be supplied to the body electrode of each of the first, second, third, and fourth transistors.

In an embodiment, the third scan line may be a scan line identical to the second scan line.

In an embodiment, the horizontal period may include a first period, a second period, and a third period. During the first period and the second period, a voltage of reference power may be supplied to the data line, and during the third period, a voltage of a data signal may be supplied to the data line.

In an embodiment, the reference power may be set to a voltage value between the first driving power and the second driving power.

In an embodiment, second initialization power may be supplied to the fourth power line, and the reference power may be set to a voltage equal to a voltage of the second initialization power.

In an embodiment, during the first period, the second transistor, the third transistor, and the fourth transistor may be turned on. During the second period and the third period, the second transistor may be turned on, and the third transistor and the fourth transistor may be turned off.

An embodiment of the present disclosure may provide a display device, including pixels connected to first scan lines, second scan lines, third scan lines, and data lines. Among the pixels, a pixel positioned on an i-th pixel row (i is an integer of 0 or more) and a j-th pixel column (j is an integer of 0 or more) may include: a first transistor including a first electrode electrically connected to a first power line configured to receive first driving power, a second electrode, and a gate electrode connected to a first node; a second transistor connected between a j-th data line and the first node, and configured to be turned on when a first scan signal is supplied to an i-th first scan line; a light emitting element including a first electrode connected to the second electrode of the first transistor, and a second electrode electrically connected to a second power line configured to receive second driving power; a first capacitor connected between the first node and the first electrode of the light emitting element; and a second capacitor connected between the first electrode of the light emitting element and a third power line configured to receive first initialization power.

In an embodiment, a ratio of a capacitance of the second capacitor o a capacitance of the first capacitor may be at least 0.1.

In an embodiment, the pixel positioned on the i-th pixel row and the j-th pixel column may further include: a third transistor connected between the first electrode of the light emitting element and the third power line, and configured to be turned on when a second scan signal is supplied to an i-th second scan line; a third capacitor including a first electrode, and a second electrode connected to the first node; and a fourth transistor including a first electrode electrically connected to a fourth power line configured to receive second initialization power, and a second electrode connected to the first electrode of the third capacitor, the fourth transistor being configured to be turned on when a third scan signal is supplied to an i-th third scan line.

In an embodiment, wherein each of the first, second, third, and fourth transistors may include a metal-oxide-semiconductor field-effect transistor (MOSFET) including a body electrode. The first driving power may be supplied to the body electrode o each of the first, second, third, and fourth transistors.

In an embodiment, a horizontal period in which the pixel positioned on the i-th pixel row and the j-th pixel column is driven may include a first period, a second period, and a third period. The display device may further include: a data driver configured to supply a voltage of reference power to the j-th data line during the first period and the second period, and supply a voltage of a data signal to the j-th data line during the third period; a first scan driver configured to supply the first scan signal to the i-th first scan line during the first to the third periods; a second scan driver configured to supply the second scan signal to the i-th second scan line during the first period; and a third scan driver configured to supply the third scan signal to the i-th third scan line during the first period.

In an embodiment, the reference power may be equal to the second initialization power having a voltage between the first driving power and the second driving power.

In an embodiment, the third scan line may be a scan line identical to the second scan line, and the third scan driver may be a driver identical to the second scan driver.

The objects of the present disclosure are not limited to the above-stated object, and those skilled in the art will clearly understand other not mentioned objects from the accompanying claims.

### BRIEF DESCRIPTION OF THE DRAWINGS

FIG. 1 is a diagram illustrating a transistor in accordance with an embodiment of the present disclosure.

FIG. 2 is a diagram illustrating a display device in accordance with an embodiment of the present disclosure.

FIG. 3 is a diagram illustrating an embodiment of a scan driver illustrated in FIG. 2.

FIG. 4 is a diagram illustrating a pixel in accordance with an embodiment of the present disclosure.

FIG. 5 is a waveform diagram illustrating an embodiment of a method of driving the pixel shown in FIG. 4.

FIGS. 6A to 6D are diagrams illustrating a process of operating the pixel corresponding to the driving waveform in FIG. 5.

FIG. 7 is a diagram illustrating a voltage range of a data signal corresponding to the capacitance of a second capacitor.

FIG. 8 is a diagram showing voltage variation of a second node in an embodiment of the present disclosure and in a comparative example.

FIG. 9 is a diagram showing a current error in an embodiment of the present disclosure and in a comparative example.

FIG. 10 is a diagram illustrating a pixel in accordance with an embodiment of the present disclosure.

FIGS. 11 to 14 are diagrams illustrating electronic devices in accordance with various embodiments.

### DETAILED DESCRIPTION

Hereinafter, embodiments of the present invention will be described in detail with reference to the attached drawings, such that those skilled in the art can easily make and use the present invention. The present disclosure may be implemented in various forms, and is not limited to the embodiments to be described herein below.

In the drawings, portions which are not related to the present disclosure will be omitted in order to explain the present disclosure more clearly. Reference should be made to the drawings, in which similar reference numerals are used throughout the different drawings to designate similar components. Therefore, the aforementioned reference numerals may be used in other drawings.

For reference, the size of each component and the thicknesses of lines illustrating the component are arbitrarily represented for the sake of explanation, and the present disclosure is not limited to what is illustrated in the drawings. In the drawings, the thicknesses of the components may be exaggerated to clearly depict multiple layers and areas.

Furthermore, the expression “being the same” may mean “being substantially the same”. In other words, the expression “being the same” may include a range that can be tolerated by those skilled in the art. The other expressions may also be expressions from which the term “substantially” has been omitted.

Some embodiments are described in the accompanying drawings in connection with functional blocks, units and/or modules. Those skilled in the art will understand that such blocks, units, and/or modules are physically implemented by logic circuits, discrete components, microprocessors, hard-wired circuits, memory elements, line connections, and other electronic circuits. This may be formed using semiconductor-based fabrication techniques or other fabrication techniques. For blocks, units, and/or modules implemented by a microprocessor or other similar hardware, they may be programmed and controlled using software to perform various functions discussed herein, and may be optionally driven by firmware and/or software. In addition, each block, unit, and/or module may be implemented by dedicated hardware, or be implemented by a combination of the dedicated hardware which performs some functions and a processor which performs different functions (e.g. one or more programmed microprocessors and related circuits). Furthermore, in some embodiments, blocks, units and/or modules may be physically separated into two or more individual blocks, units and/or modules which interact with each other without departing from the scope of the inventive concept. In some embodiments, blocks, units and/or modules may be physically combined into more complex blocks, units and/or modules without departing from the scope of the inventive concept.

The term “connection” or “coupling” between two components may encompass both electrical connection and physical connection, but the present disclosure is not limited thereto. For example, the term “connection” used in description with reference to a circuit diagram may refer to electrical connection, and the term “connection” used in description with reference to a sectional view or a plan view may refer to physical connection.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure.

However, the present disclosure is not limited to the following embodiments and may be modified into various forms. Each embodiment to be described below may be implemented alone, or combined with at least another embodiment to make various combinations of embodiments.

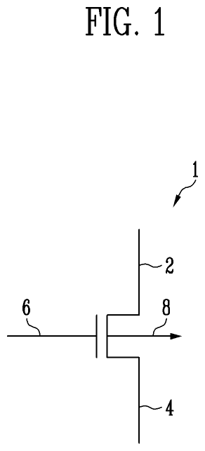

FIG. 1 is a diagram illustrating a transistor in accordance with an embodiment of the present disclosure.

Referring to FIG. 1, the transistor 1 in accordance with an embodiment of the present disclosure may include a first electrode 2, a second electrode 4, a gate electrode 6, and a body electrode 8. For example, the transistor 1 may be a metal-oxide-semiconductor field-effect transistor (MOSFET). The transistor 1 (e.g., a MOSFET) including a body electrode 8 is suitable for implementing a high-resolution pixel due to a reduced mounting area thereof.

The transistor 1 may be formed on a silicon wafer. For example, a panel may be implemented by stacking layers such as a transistor layer, an emission layer, and a cover layer on the silicon wafer. However, the foregoing description is illustrative, and the transistor 1 may be formed on various known substrates (e.g., a glass substrate).

The first electrode 2 of the transistor 1 may be set to a drain electrode (or a source electrode), and the second electrode 4 thereof may be set to a source electrode (or a drain electrode). In the case where the transistor 1 includes the body electrode 8, a threshold voltage of the transistor 1 may be changed by body effect. The body effect refers to a change in the threshold voltage of the transistor 1 due to a voltage difference between the body electrode 8 and the source electrode (or the second electrode 4).

Therefore, in the case where the transistor 1 including the body electrode 8 is formed as a driving transistor of the pixel, the voltage difference between the body electrode 8 and the second electrode 4 is maintained at a relatively low value. Therefore, in embodiments of the present disclosure, there is proposed a pixel that uses the transistor 1 including the body electrode 8 as a driving transistor and is able to compensate for threshold voltage.

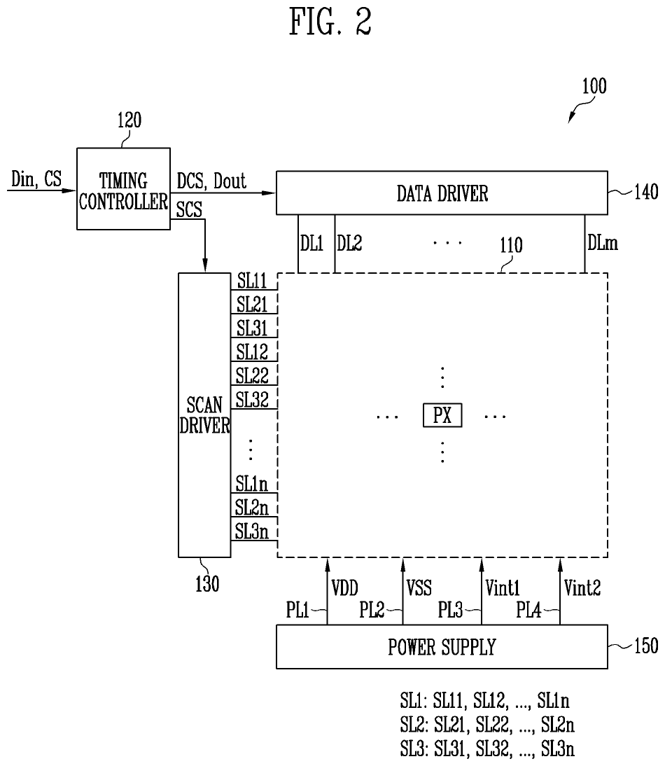

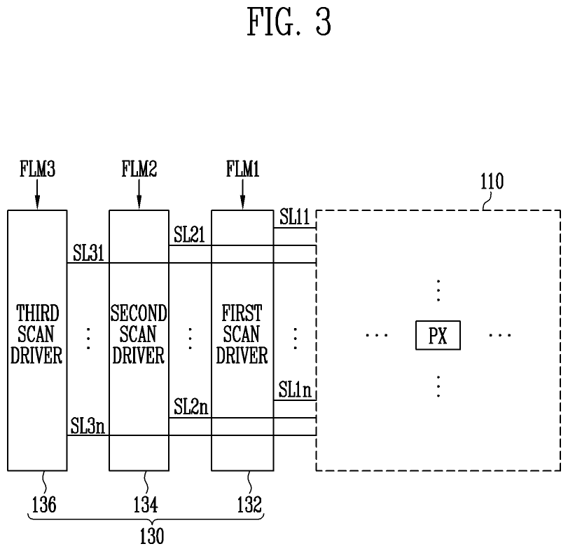

FIG. 2 is a diagram illustrating a display device 100 in accordance with an embodiment of the present disclosure. FIG. 3 is a diagram illustrating an embodiment of a scan driver 130 illustrated in FIG. 2.

Referring to FIG. 2, the display device 100 in accordance with an embodiment of the present disclosure may include a pixel component 110 (or a panel), a timing controller 120, the scan driver 130, a data driver 140, and a power supply 150. The aforementioned components may be implemented as separate integrated circuits. Two or more components of the aforementioned components may be implemented into a single integrated circuit. The scan driver 130 may be formed to be included in the pixel component 110.

The pixel component 110 may include pixels PX connected to first scan lines SL11, SL12, . . . , and SL1n, second scan lines SL21, SL22, . . . , and SL2n, third scan lines SL31, SL32, . . . , and SL3n, data lines DL1, DL2, . . . , and DLm, and power lines PL1, PL2, PL3, and PL4 (where n and m are integers of 0 or more).

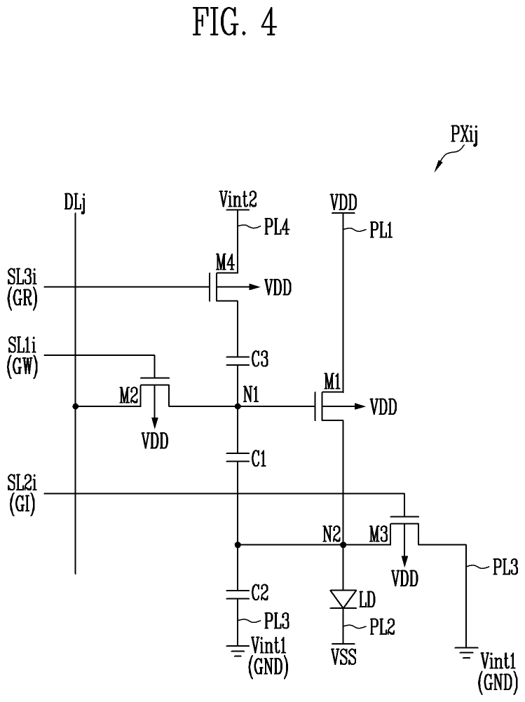

For example, a pixel PXij (refer to FIG. 4) positioned on an i-th horizontal line (or a pixel row) and a j-th vertical line (or a pixel column) may be connected to an i-th first scan line SL1i, an i-th second scan line SL2i, an i-th third scan line SL3i, and a j-th data line DLj (where i is an integer of n or less, and j is an integer of m or less).

The pixels PX may be selected on a horizontal line basis {e.g., pixels PX connected to the same scan line may be grouped into one horizontal line (or a pixel row)} when a first scan signal is supplied to the first scan lines SL11 to SL1n. Each of the pixels PX that are selected by the first scan signal may receive a data signal from a corresponding data line (any one of DL1 to DLm) connected therewith. The pixels PX that receive data signals may generate certain levels of luminance of light in response to voltages of the data signals.

The scan driver 130 may receive a scan driving control signal SCS from the timing controller 120. The scan driving signal SCS may include at least one scan start signal and clock signals required for driving the scan driver 130. The scan driver 130 may generate a first scan signal, a second scan signal, and a third scan signal while shifting the scan start signal in response to the clock signals.

To achieve the foregoing purpose, as illustrated in FIG. 3, the scan driver 130 may include a first scan driver 132, a second scan driver 134, and a third scan driver 136.

The first scan driver 132 may receive a first scan start signal FLM1 and generate first scan signals while shifting the first scan start signal FLM1 in response to a clock signal. The first scan driver 132 may sequentially supply the first scan signals to the first scan lines SL11 to SL1n.

The second scan driver 134 may receive a second scan start signal FLM2 and generate second scan signals while shifting the second scan start signal FLM2 in response to a clock signal. The second scan driver 134 may sequentially supply the second scan signals to the second scan lines SL21 to SL2n.

The third scan driver 136 may receive a third scan start signal FLM3 and generate third scan signals while shifting the third scan start signal FLM3 in response to a clock signal. The third scan driver 136 may sequentially supply the third scan signals to the third scan lines SL31 to SL3n.

Each of the first scan signals, the second scan signals, and the third scan signals may be set to a gate-on voltage to allow the transistors included in the pixels PX to be turned on.

For example, a first scan signal, a second scan signal, and a third scan signal of a low level may be supplied to a P-type transistor. A first scan signal, a second scan signal, and a third scan signal of a high level may be supplied to an N-type transistor. The transistor supplied with the first scan signal, the second scan signal, or the third scan signal may be turned on in response to the first scan signal, the second scan signal, or the third scan signal.

The supply of the first scan signal, the second scan signal, and the third scan signal may mean that a gate-on voltage is supplied to the first scan line SL1, the second scan line SL2, and the third scan line SL3. Absence of the first scan signal, the second scan signal, and the third scan signal may mean that a gate-off voltage is supplied to the first scan line SL1, the second scan line SL2, and the third scan line SL3.

Although FIG. 3 illustrates that the first scan driver 132, the second scan driver 134, and the third scan driver 136 are respectively connected with the first scan line SL1, the second scan line SL2, and the third scan line SL3, embodiments of the present disclosure are not limited thereto. For example, at least two scan lines among the first scan line SL1, the second scan line SL2, and the third scan line SL3 (i.e., at least two of SL1, SL2, and SL3) may be driven by a single scan driver.

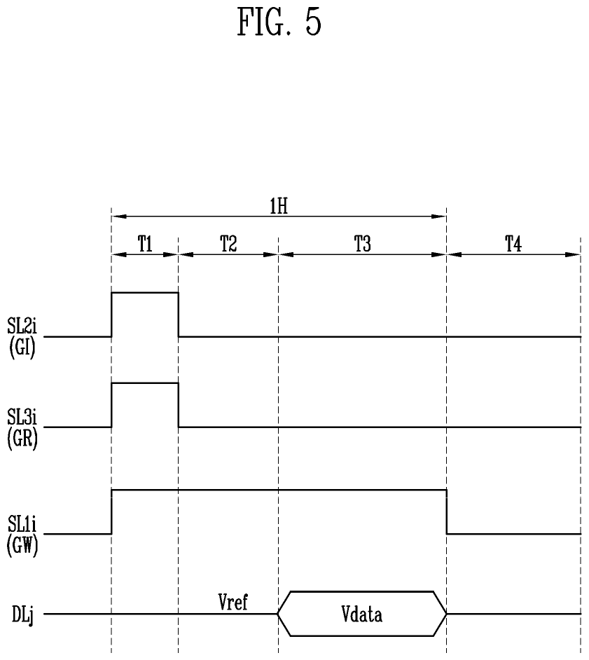

The data driver 140 may receive output data Dout and a data driving signal DCS from the timing controller 120. The data driving signal DCS may include a sampling signal and/or timing signals required for driving the data driver 140. The data driver 140 may generate data signals, based on the data driving signal DCS and the output data Dout. For example, the data driver 140 may generate an analog data signal, based on a grayscale level of the output data Dout. The data driver 140 may sequentially supply a voltage of reference power Vref and voltages of data signals Vdata to the data lines DL1 to DLm during one horizontal period 1H (refer to FIG. 5). The reference power Vref may be set as a constant voltage.

The data driver 140 may be positioned on an upper side of the pixel component 110, as illustrated in FIG. 2. However, the present disclosure is not limited thereto, and the data driver 140 may be positioned on a lower side of the pixel component 110.

The timing controller 120 may receive input data Din and a control signal CS from a host system through an interface. For example, the timing controller 120 may receive input data Din and a control signal CS from at least one of a graphics processing unit (GPU), a central processing unit (CPU), and an application processor (AP) that are included in the host system. The control signal CS may include various signals including a clock signal.

The timing controller 120 may generate a scan driving signal SCS and a data driving signal DCS, based on the control signal CS. The scan driving signal SCS and the data driving signal DCS may be respectively supplied to the scan driver 130 and the data driver 140.

The timing controller 120 may rearrange the input data Din to match specifications of the display device 100. Furthermore, the timing controller 120 may correct the input data Din to generate output data Dout, and supply the output data Dout to the data driver 140. In an embodiment, the timing controller 120 may correct the input data Din in response to optical measurement results obtained during the manufacturing process.

The power supply 150 may generate various power voltages required for driving the display device 100. For example, the power supply 150 may generate first driving power VDD, second driving power VSS, first initialization power Vint1, and second initialization power Vint2.

The first driving power VDD may be provided to supply driving current to the pixels PX. The second driving power VSS may be provided to receive the driving current from the pixels PX. During a period in which the pixels PX are set to an emission state, the first driving power VDD may be set to a voltage higher than that of the second driving power VSS.

The first initialization power Vint1 may be a voltage provided to initialize a first electrode (or an anode electrode) of a light emitting element LD (refer to FIG. 4) included in each of the pixels PX. The first initialization power Vint1 may have a voltage value causing the light emitting element LD to be turned off when supplied to the first electrode of the light emitting element LD. For example, the first initialization power Vint1 may be set to a ground potential GND. In the case where the first initialization power Vint1 is set to the ground potential GND, the third power line PL3 may be omitted.

The second initialization power Vint2 may be a voltage provided to initialize a third capacitor C3. The second initialization power Vint2 may be set to the same voltage as the reference power Vref.

Generated from the power supply 150, the first driving power VDD may be supplied to the first power line PL1, the second driving power VSS may be supplied to the second power line PL2, the first initialization power Vint1 may be supplied to the third power line PL3, and the second initialization power Vint2 may be supplied to the fourth power line PL4. The first power line PL1, the second power line PL2, the third power line PL3, and the fourth power line PL4 may be connected in common to the pixels PX, but embodiments of the present disclosure are not limited thereto.

In an embodiment, the first power line PL1 may include a plurality of power lines. The power lines may be connected to different pixels PX. In an embodiment, the second power line PL2 may include a plurality of power lines. The power lines may be connected to different pixels PX. In an embodiment, the third power line PL3 may include a plurality of power lines. The power lines may be connected to different pixels PX. In an embodiment, the fourth power line PL4 may include a plurality of power lines. The power lines may be connected to different pixels PX. In other words, in an embodiment of the present disclosure, the pixels PX may be connected to any one of the first power lines PL1, any one of the second power lines PL2, any one of the third power lines PL3, and any one of the fourth power lines PL4.

FIG. 4 is a diagram illustrating a pixel PXij in accordance with an embodiment of the present disclosure. In FIG. 4, it is determined to represent the pixel PXij positioned on an i-th horizontal line and a j-th vertical line.

Referring to FIG. 4, the pixel PXij in accordance with an embodiment of the present disclosure may be connected to corresponding signal lines SL1i, SL2i, SL3i, and DLj. For example, the pixel PXij may be connected to the i-th first scan line SL1i, the i-th second scan line SL2i, the i-th third scan line SL3i, and the j-th data line DLj. In an embodiment, the pixel PXij may be also connected to the first power line PL1, the second power line PL2, the third power line PL3, and the fourth power line PL4.

The pixel PXij in accordance with an embodiment of the present disclosure may include a light emitting element LD, and a pixel circuit configured to control the amount of current to be supplied to the light emitting element LD.

The light emitting element LD may be connected between the first power line PL1 and the second power line PL2. For example, a first electrode (or an anode electrode) of the light emitting element LD may be electrically connected to the first power line PL1 via a second node N2 and a first transistor M1. A second electrode (or a cathode electrode) of the light emitting element LD may be electrically connected to the second power line PL2. The light emitting element LD may generate light of a certain luminance corresponding to the amount of current that is supplied from the first power line PL1 to the second power line PL2 via the pixel circuit.

An organic light emitting diode may be selected as the light emitting element LD. Furthermore, an inorganic light emitting diode such as a micro light emitting diode (LED) or a quantum dot light emitting diode may be selected as the light emitting element LD. The light emitting element LD may be an element formed of a combination of organic material and inorganic material. Although FIG. 4 illustrates that the pixel PXij includes a single light emitting element LD, the pixel PXij in an embodiment may include a plurality of light emitting elements LD. The plurality of light emitting elements LD may be connected in series, parallel or a combination.

The pixel circuit may include the first transistor M1, a second transistor M2, a third transistor M3, a fourth transistor M4, a first capacitor C1, a second capacitor C2, and a third capacitor C3.

Each of the first to fourth transistors M1 to M4 may be a MOSFET including a body electrode. In this case, the first to fourth transistors M1 to M4 may be mounted in a relatively small area, thus allowing the pixel PXij to be applied to a high-resolution panel. The body electrode of the first to fourth transistors M1 to M4 may be supplied with first driving power VDD. For example, the body electrode of the first to fourth transistors M1 to M4 may be electrically connected to the first power line PL1.

In an embodiment, at least one transistor of the first to fourth transistors M1 to M4 may be formed of a transistor other than a MOSFET. For example, at least one transistor of the first to fourth transistors M1 to M4 may be formed of a transistor that does not include a body electrode. For example, at least one transistor of the first to fourth transistors M1 to M4 may be formed of any one transistor among a thin film transistor (TFT), a field effect transistor (FET), and a bipolar junction transistor (BJT).

In an embodiment, each of the first to fourth transistors M1 to M4 may be formed of an N-type transistor. However, this is illustrative, and at least one of the first to fourth transistors M1 to M4 may be substituted with a P-type transistor.

The first transistor M1 (or a driving transistor) may include a first electrode electrically connected to the first power line PL1, and a second electrode connected to the second node N2. Here, the second node N2 may refer to a node connected to the first electrode of the light emitting element LD. In the foregoing description, the term “connected” implies being electrically coupled. A gate electrode of the first transistor M1 may be connected to a first node N1. The first transistor M1 may control, in response to the voltage of the first node N1, the amount of current to be supplied from the first driving power VDD to the second driving power VSS via the light emitting element LD.

A first electrode of the second transistor M2 may be electrically connected to a data line DLj, and a second electrode thereof may be connected to the first node N1. A gate electrode of the second transistor M2 may be electrically connected to the first scan line SL1i. When a first scan signal GW is supplied to the first scan line SL1i, the second transistor M2 may be turned on to electrically connect the data line DLj with the first node N1.

The third transistor M3 may include a first electrode connected to the second node N2, and a second electrode electrically connected to the third power line PL3. A gate electrode of the third transistor M3 may be electrically connected to the second scan line SL2i. When a second scan signal GI is supplied to the second scan line SL2i, the third transistor M3 may be turned on to electrically connect the second node N2 with the third power line PL3.

The fourth transistor M4 may include a first electrode electrically connected to the fourth power line PL4, and a second electrode electrically connected to a first electrode of the third capacitor C3. A gate electrode of the fourth transistor M4 may be electrically connected to the third scan line SL3i. When a third scan signal GR is supplied to the third scan line SL3i, the fourth transistor M4 may be turned on to electrically connect the fourth power line PL4 with the first electrode of the third capacitor C3.

The first capacitor C1 may include a first electrode connected to the first node N1, and a second electrode connected to the second node N2. The first capacitor C1 may store a voltage between the first node N1 and the second node N2. The first capacitor C1 may function as a coupling capacitor and control the voltage of the second node N2 in response to voltage variation on the first node N1.

The second capacitor C2 may include a first electrode connected to the second node N2, and a second electrode electrically connected to the third power line PL3. The second capacitor C2, along with the first capacitor C1, may control voltage variation on the second node N2 in response to the voltage variation on the first node N1.

The third capacitor C3 may include a first electrode connected to the second electrode of the fourth transistor M4, and a second electrode connected to the first node N1.

FIG. 5 is a waveform diagram illustrating an embodiment of a method of driving the pixel PXij shown in FIG. 4.

Referring to FIG. 5, a horizontal period 1H (or a specific horizontal period) in which a data signal is supplied to the pixel PXij positioned on the i-th horizontal line and the j-th vertical line may be divided into a first period T1, a second period T2, and a third period T3.

The data driver 140 may supply a voltage of the reference power Vref to the data line DLj during the first period T1 and the second period T2, and may supply a voltage Vdata of the data signal to the data line DLj during the third period T3. The reference power Vref may be set to a voltage between the first driving power VDD and the second driving power VSS. For example, the reference power Vref may be set to the same voltage as the second initialization power Vint2.

The scan driver 130 (or the first scan driver 132) may supply a first scan signal GW to the first scan line SL1i during the first to third periods T1 to T3.

The scan driver 130 (or the second scan driver 134) may supply a second scan signal GI to the second scan line SL2i during the first period T1.

The scan driver 130 (or the third scan driver 136) may supply a third scan signal GR to the third scan line SL3i during the first period T1.

The first period T1 may be a period in which the first capacitor C1, the second capacitor C2, the third capacitor C3, and the light emitting element LD are initialized. The first period T1 may be referred to as an initialization period.

The second period T2 may be a period in which the threshold voltage of the first transistor M1 is compensated for. During the second period T2, a voltage corresponding to the threshold voltage of the first transistor M1 may be stored in the first capacitor C1. The second period T2 may be referred to as a threshold voltage compensation period.

The third period T3 may be a period in which the voltage Vdata of the data signal is supplied from the data line DLj to the pixel PXij. During the third period T3, the voltage Vdata of the data signal may be supplied to the first node N1. The third period T3 may be referred to as a data write period.

The fourth period T4 is a period in which the light emitting element LD emits light. During the fourth period T4, the first transistor M1 may control, in response to the voltage of the first node N1, the amount of current flowing from the first driving power VDD to the second driving power VSS via the light emitting element LD. During the fourth period T4, the light emitting element LD may emit light at a luminance corresponding to the amount of current. The fourth period T4 may be referred to as an emission period.

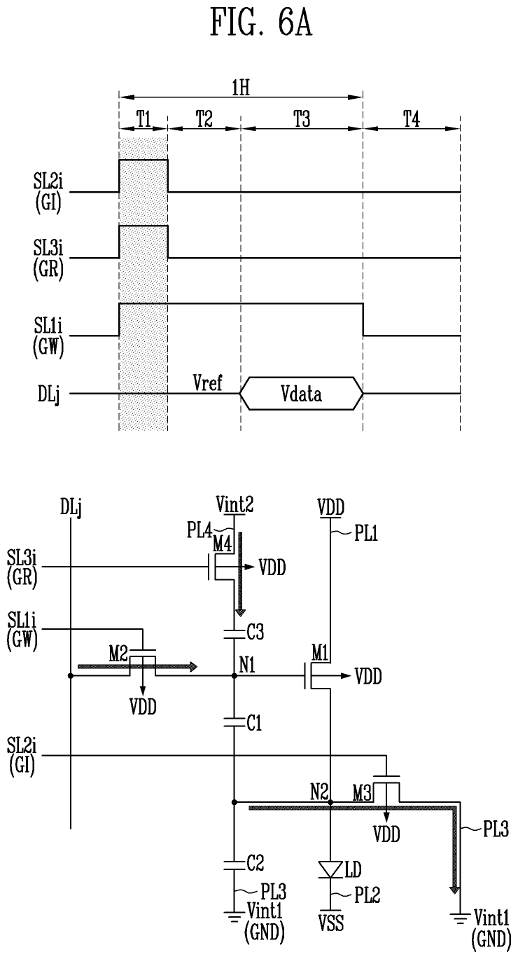

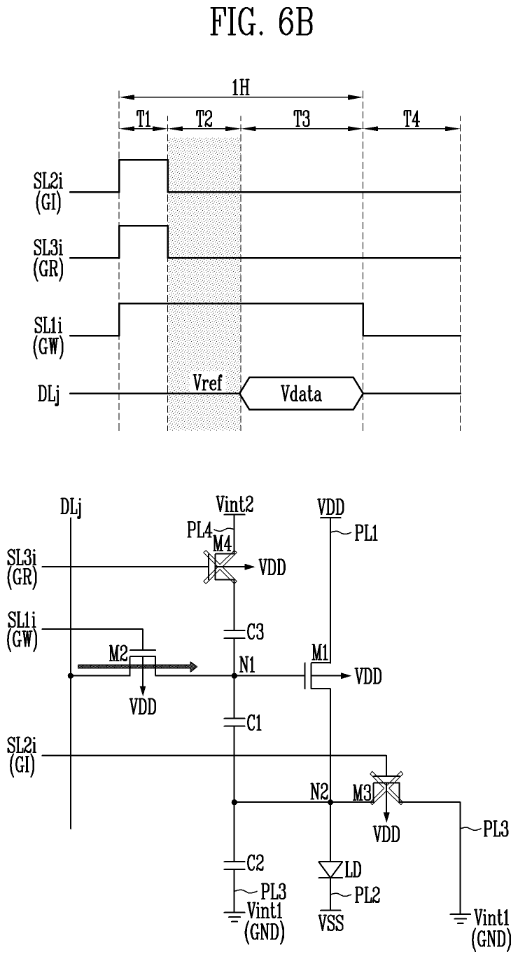

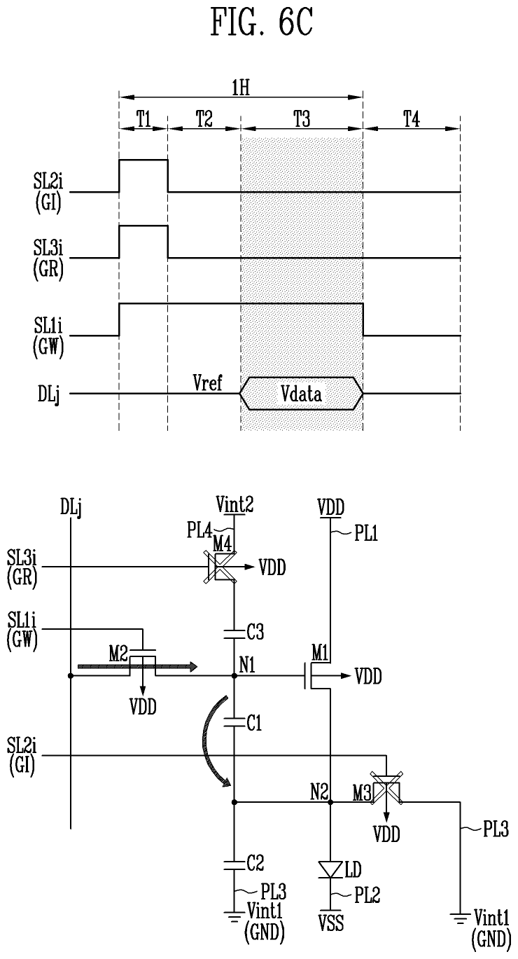

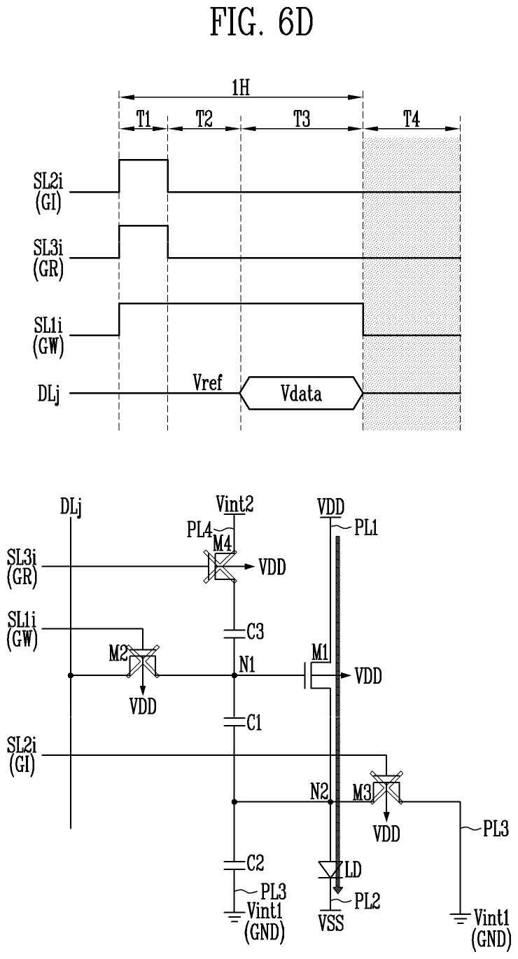

FIGS. 6A to 6D are diagrams illustrating a process of operating the pixel corresponding to the driving waveform in FIG. 5.

Referring to FIG. 6A, during the first period T1, the first scan signal GW is supplied to the first scan line SL1i, the second scan signal GI is supplied to the second scan line SL2i, and the third scan signal GR is supplied to the third scan line SL3i.

The first scan signal GW being supplied to the first scan line SL1i turns on the second transistor M2. If the second transistor M2 is turned on, the data line DLj may be electrically connected to the first node N1. As a result, the voltage of the reference power Vref is supplied from the data line DLj to the first node N1.

The second scan signal GI being supplied to the second scan line SL2i turns on the third transistor M3. If the third transistor M3 is turned on, the voltage of the first initialization power Vint1 is supplied to the second node N2. If the voltage of the first initialization power Vint1 is supplied to the second node N2, the light emitting element LD may be initialized. For example, a parasitic capacitor (not shown) of the light emitting element LD may be discharged by the voltage of the first initialization power Vint1. Here, the first initialization power Vint1 may be set to a voltage at which the light emitting element LD does not emit light. As a result, the light emitting element LD may be set to a non-emission state. For example, the initialization power Vint may be set to the ground potential GND.

If the third scan signal GR is supplied to the third scan line SL3i, the fourth transistor M4 is turned on. If the fourth transistor M4 is turned on, the voltage of the second initialization power Vint2 is supplied to the first electrode of the third capacitor C3. Here, the voltage of the second initialization power Vint2 is supplied to the first electrode of the third capacitor C3, and the voltage of the reference power Vref is supplied to the second electrode of the third capacitor C3. In this case, the third capacitor C3 may be initialized regardless of the voltage in a previous frame period. For example, the reference power Vref and the second initialization power Vint2 may be set to the same voltage. In this case, the voltage charged into the third capacitor C3 during the previous frame period may be discharged.

During the first period T1, the voltage of the reference power Vref is supplied to the first node N1 (from the data line DLj), and the voltage of the first initialization power Vint1 is supplied to the second node N2. Therefore, the first capacitor C1 may be initialized regardless of the voltage in the previous frame period. Furthermore, because the voltage of the first initialization power Vint1 is supplied to the second node N2 during the first period T1, the second capacitor C2 may be initialized regardless of the voltage in the previous frame period.

In other words, in the first period T1, the second transistor M2, the third transistor M3, and the fourth transistor M4 may be turned on. Consequently, the first capacitor C1, the second capacitor C2, the third capacitor C3, and the light emitting element LD may be initialized.

Referring to FIG. 6B, during the second period T2, the supply of the second scan signal GI to the second scan signal SL2i is interrupted, and the supply of the third scan signal GR is interrupted. If the supply of the second scan signal GI to the second scan line SL2i is interrupted, the third transistor M3 is turned off. If the supply of the third scan signal GR to the third scan line SL23i is interrupted, the fourth transistor M4 is turned off.

During the second period T2, the supply of the first scan signal GW to the first scan line SL1i is maintained, so that the second transistor M2 may remain turned on. If the second transistor M2 remains turned on, the voltage of the reference power Vref is supplied to the first node N1. Here, the voltage of the reference power Vref may be set to allow the first transistor M1 to be turned on.

If the first transistor M1 is turned on while the voltage of the reference power Vref is supplied to the first node N1, the voltage of the second node N2 is increased to a voltage acquired by subtracting the threshold voltage of the first transistor M1 from the voltage of the reference power Vref. As a result, the first transistor M1 is turned off.

During the second period T2, the voltage of the first node N1 is set to the voltage of the reference power Vref, and the voltage of the second node N2 is set to a voltage acquired by subtracting the threshold voltage of the first transistor M1 from the voltage of the reference power Vref. Therefore, during the second period T2, the threshold voltage of the first transistor M1 may be stored in the first capacitor C1. In addition, the voltage of the reference power Vref may be set to a voltage at which the light emitting element LD is turned off when the voltage acquired by subtracting the threshold voltage of the first transistor M1 from the voltage of the reference power Vref is applied to the second node N2.

Referring to FIG. 6C, during the third period T3, the second transistor M2 remains turned on by the first scan signal GW supplied to the first scan line SL1i. In this case, the voltage Vdata of the data signal may be supplied from the data line DLj to the second node N2.

If the voltage Vdata of the data signal is supplied to the second node N2, the voltage on the first node N1 may change from the voltage of the reference voltage Vref to the voltage Vdata of the data signal. The voltage on the second node N2 may also change due to the coupling of the first capacitor C1.

Here, voltage variation of the second node N2 may be determined in response to a ratio of the first capacitor C1 and the second capacitor C2. For example, the voltage of the second node N2 may change from the voltage acquired by subtracting the threshold voltage of the first transistor from the voltage of the reference power Vref, by a value acquired by multiplying the voltage variation of the first node N1 by C1/(C1+C2). In the case where the voltage variation of the second node N2 is controlled by the ratio of the first capacitor C1 and the second capacitor C2, the voltage range of the data signal may be sufficiently widened.

The amount of current flowing from the first transistor M1 to the light emitting element LD during the fourth period T4 may be determined by a voltage (i.e., Vgs) of the first node N1 and the second node N2. In the case where the voltage variation of the second node N2 is controlled by the ratio of the first capacitor C1 and the second capacitor C2, the voltage variation of the second node N2 may be set to a small value in correspondence to the voltage variation of the first node N1. As a result, the voltage range of the data signal may be sufficiently widened.

For example, in the case where the voltage range of the data signal is relatively small, there is a need to implement various grayscale levels (e.g., 256 grayscale levels) using a small voltage range. Consequently, it becomes difficult to represent accurate grayscale levels. On the other hand, as described in embodiments of the present disclosure, in the case where the voltage on the second node N2 is controlled by the ratio of the first capacitor C1 and the second capacitor C2, the voltage range of the data signal may be set to a sufficient large range. As a result, the grayscale levels can be easily implemented.

Referring to FIG. 6D, during the fourth period T4, the supply of the first scan signal GW to the first scan line SL1i is interrupted, so that the second transistor M2 is set to a turn-off state.

The first transistor M1 may control, in response to the voltage of the first node N1 and the second node N2, the amount of current to be supplied from the first driving power supply VDD to the second driving power supply VSS via the light emitting element LD. The light emitting element LD may generate light having a luminance corresponding to the amount of current supplied from the first transistor M1.

The amount of current supplied from the first transistor M1 to the light emitting element LD during the fourth period T4 may be determined regardless of the threshold voltage of the first transistor M1, as shown in Equation 1.

$$I L D = \frac{k}{2} {( \frac{C 1}{C 1 + C 2} ( V data - V ref ) )}^{2} \qquad [ Equation 1 ]$$

In Equation 1, ILD denotes current supplied to the light emitting element LD, and k denotes a proportional constant determined by the mobility of the first transistor M1, parasitic capacitance, channel capacitance, and the like.

Referring to Equation 1, it can be understood that the amount of current supplied from the first transistor M1 is determined by the voltage Vdata of the data signal, the voltage of the reference power Vref, and the ratio of the first capacitor C1 and the second capacitor C2, regardless of the threshold voltage of the first transistor M1.

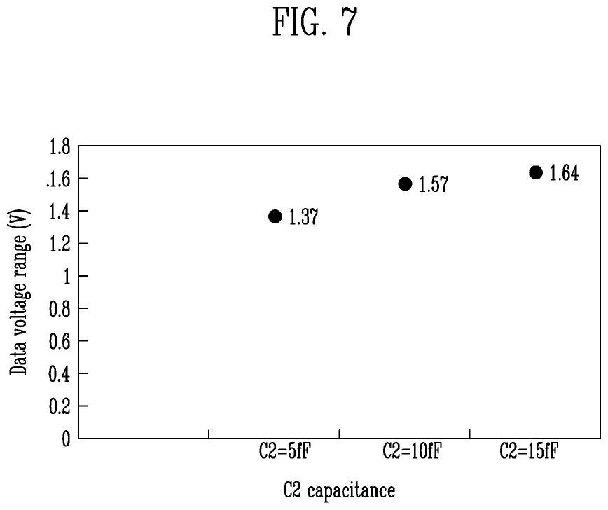

FIG. 7 is a diagram illustrating a voltage range of a data signal corresponding to the capacitance of the second capacitor C2.

Referring to FIG. 7, it can be understood that as the capacitance of the second capacitor C2 increases, the voltage range of the data signal also increases. In other words, as the capacitance of the second capacitor C2 increases, the voltage variation of the second node N2 in correspondence with the voltage variation of the first node N1 decreases. As a result, the voltage range of the data signal may increase.

In an embodiment of the present disclosure, the first capacitor C1 and the second capacitor C2 may be set in capacitance such that C2/C1 is 0.1 or more. For example, in the case where the capacitance of the first capacitor C1 and the second capacitor C2 satisfies C2/C1≥0.1, the voltage range of the data signal may be set to a large range, and the capacitors C1 and C2 may be easily formed during the manufacturing process.

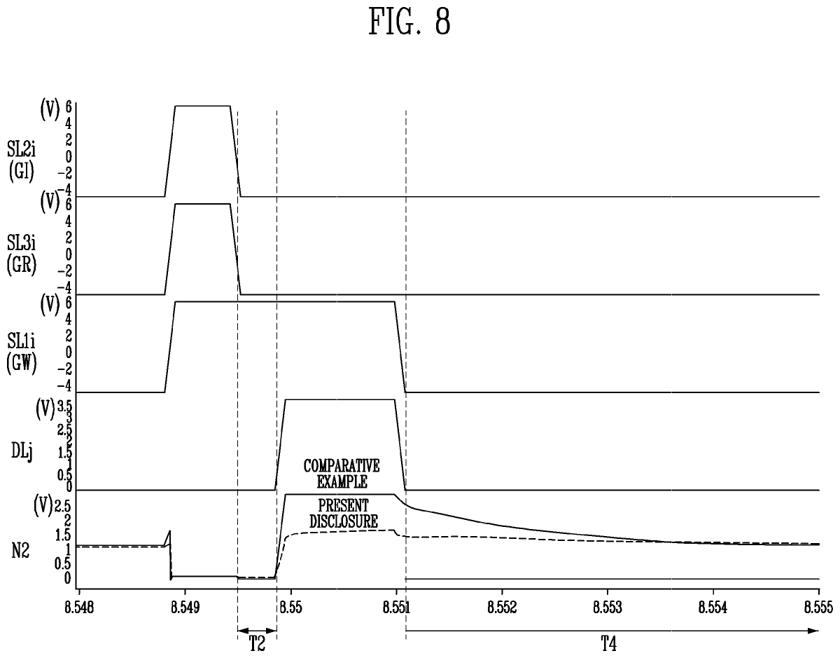

FIG. 8 is a diagram showing the voltage variation of the second node in an embodiment of the present disclosure and in a comparative example. In FIG. 8, the embodiment of the present disclosure refers to the pixel shown in FIG. 4, and the comparative example refers to the case where the second capacitor C2 is removed from the pixel in FIG. 4. In FIG. 8, the Y-axis denotes voltage, and the X-axis denotes time.

Referring to FIG. 8, in the case of the comparative example, when the voltage Vdata of the data signal is supplied, the voltage on the second node N2 significantly changes. In other words, in the case where the second capacitor C2 is removed from the pixel PXij of FIG. 4, the voltage variation of the first node N1 may be directly transmitted to the second node N2 by the first capacitor C1. In this case, the voltage on the second node N2 may significantly change in correspondence with the voltage Vdata of the data signal.

On the other hand, in the embodiment of the present disclosure, the voltage variation of the first node N1 may be transmitted to the second node N2 in correspondence with the ratio of the first capacitor C1 and the second capacitor C2, whereby the voltage on the second node N2 may slightly change in correspondence with the voltage Vdata of the data signal.

Here, the slight change in voltage on the second node N2 refers to that a voltage difference (i.e., Vbs) between the body electrode and the source electrode of the first transistor M1 remains low. In other words, in the embodiment of the present disclosure, the use of the first transistor M1 configured of an MOSFET allows for maintaining a low voltage difference between the body electrode and the source electrode. Hence, the reliable driving operation can be secured.

For example, in the case of the comparative example, the voltage difference (i.e., Vbs) between the body electrode and the source electrode of the first transistor M1 is set to a large value. Hence, in the case where the threshold voltage of the first transistor M1 changes by +50 mV, the current error on grayscale level 32 is set to approximately 76.06%.

On the other hand, in the case of the embodiment of the present disclosure, the voltage difference (i.e., Vbs) between the body electrode and the source electrode of the first transistor M1 is set to a relatively small value. Hence, in the case where the threshold voltage of the first transistor M1 changes by +50 mV, the current error at grayscale level 32 is set to approximately 58%.

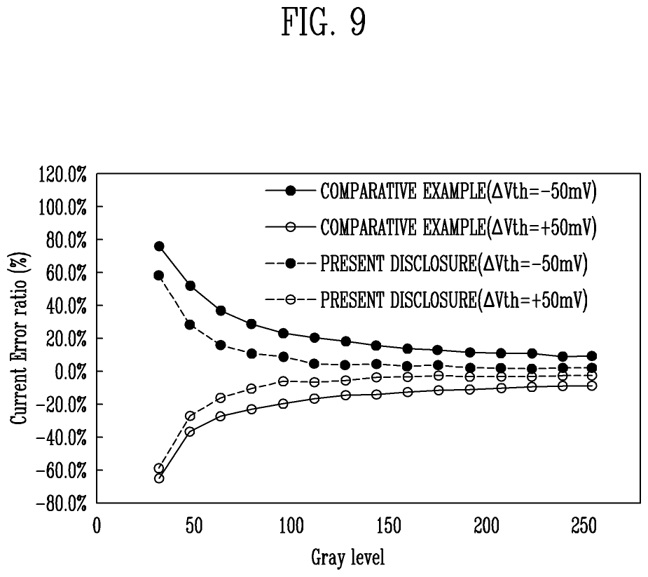

FIG. 9 is a diagram illustrating a current error in an embodiment of the present disclosure and in a comparative example. In FIG. 9, the X-axis denotes the grayscale level, and the Y-axis denotes the current error. The current error is expressed as a percentage [%] and represents variation in driving current in response to a change in threshold voltage of the first transistor M1. FIG. 9 illustrates the current error when the threshold voltage of the first transistor M1 changes by +50 mV.

Referring to FIG. 9, in the case of the comparative example, when the threshold voltage of the first transistor M1 changes by +50 mV, the current error may be set to approximately +76% or less. In contrast, in the case of the embodiment of the present disclosure, when the threshold voltage of the first transistor M1 changes by +50 m V, the current error may be set to approximately +58% or less.

Compared to the comparative example, in the case of the present disclosure, the current error in correspondence with a change in threshold voltage of the first transistor M1 may be minimized.

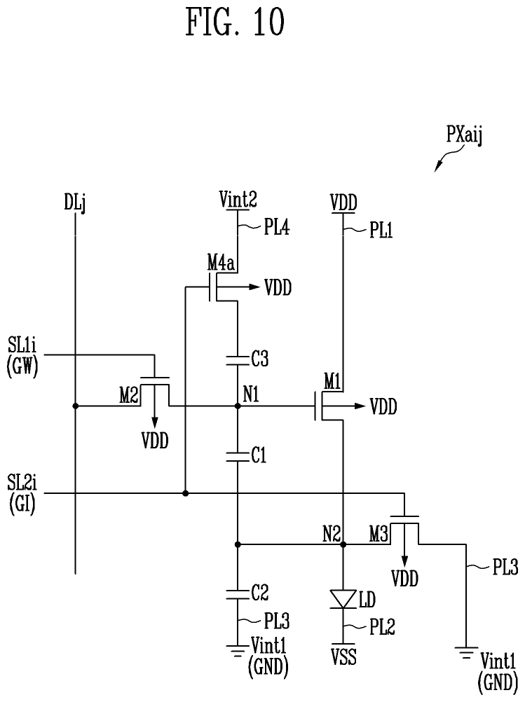

FIG. 10 is a diagram illustrating a pixel in accordance with an embodiment of the present disclosure. In the following description of FIG. 10, explanations that overlap the description of FIG. 4 will be omitted.

Referring to FIG. 10, the pixel PXaij in accordance with an embodiment of the present disclosure may be connected to corresponding signal lines SL1i, SL2i, and DLj. For example, the pixel PXaij may be connected to the i-th first scan line SL1i, the i-th second scan line SL2i, and the j-th data line DLj. In an embodiment, the pixel PXaij may also be connected to the first power line PL1, the second power line PL2, the third power line PL3, and the fourth power line PL4.

The pixel PXaij in accordance with an embodiment of the present disclosure may include a light emitting element LD, and a pixel circuit configured to control the amount of current to be supplied to the light emitting element LD.

The light emitting element LD may be connected between the first power line PL1 and the second power line PL2. The light emitting element LD may generate light of a certain luminance corresponding to the amount of current that is supplied from the first power line PL1 to the second power line PL2 via the pixel circuit.

The pixel circuit may include a first transistor M1, a second transistor M2, a third transistor M3, a fourth transistor M4a, a first capacitor C1, a second capacitor C2, and a third capacitor C3.

The fourth transistor M4a may include a first electrode electrically connected to the fourth power line PL4, and a second electrode electrically connected to a first electrode of the third capacitor C3. A gate electrode of the fourth transistor M4a may be electrically connected to the second scan line SL2i. When a second scan signal GI is supplied to the second scan line SL2i, the fourth transistor M4a may be turned on to electrically connect the fourth power line PL4 with the first electrode of the third capacitor C3.

Compared to the fourth transistor M4 shown in FIG. 4, the fourth transistor M4a has a gate electrode connected to the second scan line SL2i, but the operational process thereof is the same. Therefore, detailed descriptions pertaining to the operational process will be omitted.

In the case where the gate electrode of the fourth transistor M4a is connected to the second scan line S22i, the third scan line SL3i may be omitted. In the case where the third scan line SL3i is omitted, a mounting area of each of the pixels PX may be reduced, thus making it easier to apply the pixels PX to a high-resolution panel. Furthermore, in the case where the third scan line SL3i is omitted, the degree of design may be enhanced.

Furthermore, in the case where the third scan line SL3i is omitted, the third scan driver 136 may also be omitted. In the case where the third scan driver 136 is omitted, the mounting area of the drivers 130 may be reduced, thereby minimizing dead space.

Hereinafter, an electronic device to which the display device 100 in accordance with the aforementioned embodiments can be applied will be described.

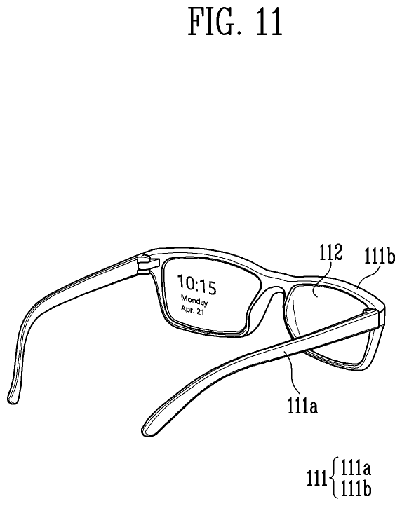

FIGS. 11 to 14 are diagrams illustrating electronic devices in accordance with various embodiments.

Referring to FIG. 11, the display device in accordance with the aforementioned embodiments may be applied to smart glasses. The smart glasses may include a frame 111 and a lens component 112. The smart glasses are a wearable electronic device, which is worn on the face of the user (e.g., covering the eyes), and may have a structure such that a portion of the frame 111 can be folded or unfolded. For example, the smart glasses may be a wearable device for augmented reality (AR).

The frame 111 may include a housing 111b which supports the lens component 112, and a leg component 111a enabling the user to wear the smart glasses. The leg component 111a is coupled to the housing 111b by a hinge and thus can be folded or unfolded.

The frame 111 may be equipped with a battery, a touch pad, a microphone, and/or a camera. Furthermore, the frame 111 may be equipped with a projector configured to output light, and/or a processor configured to control a light signal.

The lens component 112 may be an optical component configured to transmit or reflect light. The lens component 112 may include glass, and/or transparent synthetic resin.

The display device in accordance with the aforementioned embodiments may be applied to the lens component 112. For example, the user may perceive images displayed by optical signals transmitted from the projector in the frame 111 through the lens component 112. For example, the user may perceive information such as time and data displayed on the lens component 112.

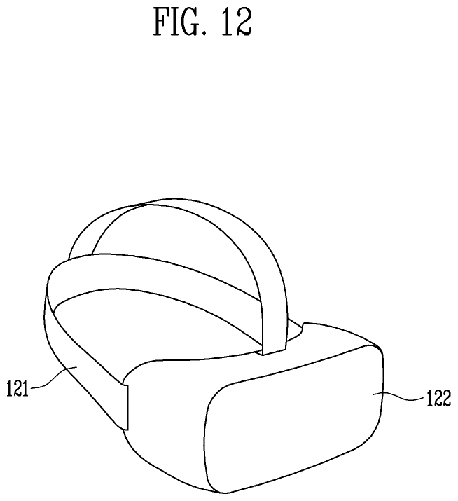

Referring to FIG. 12, the display device in accordance with the aforementioned embodiments may be applied to a head mounted display (HMD). The HMD may include a head mounting band 121 and a display receiving case 122. For example, the HMD may be a wearable electronic device, which can be worn on the head of the user.

The head mounting band 121 is coupled to the display receiving casing 122 and functions to mount the display receiving casing 122 on the head of the user. The head mounting band 121 may include a horizontal band and a vertical band for mounting the HMD to the head of the user, and may be configured such that the horizontal band encloses a side portion of the head of the user while the vertical band encloses an upper portion of the head of the user. However, the present disclosure is not limited to the foregoing embodiments. For example, the head mounting band 121 may be implemented in the form of an eyeglass frame or a helmet.

The display receiving case 122 may receive the display device, and include at least one lens. The at least one lens may provide an image to the user. For example, the display device in accordance with the aforementioned embodiments may be applied to a left-eye lens and a right-eye lens that are implemented in the display receiving case 122.

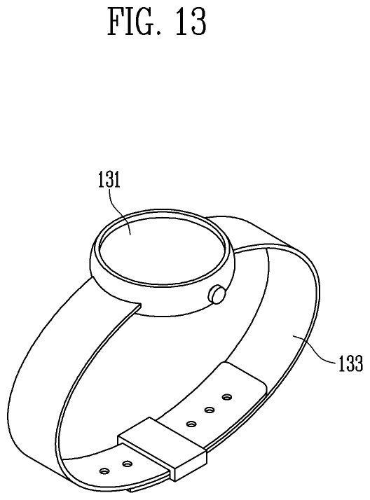

Referring to FIG. 13, the display device in accordance with the aforementioned embodiments may be applied to a smart watch. The smart watch may include a display component 131 and a strap component 133. The smart watch is a wearable electronic device. The strap component 133 may be mounted to the wrist of the user. The display device in accordance with the aforementioned embodiments may be applied to the display component 131. For example, the display device 131 may provide image data including information such as time, date, and more.

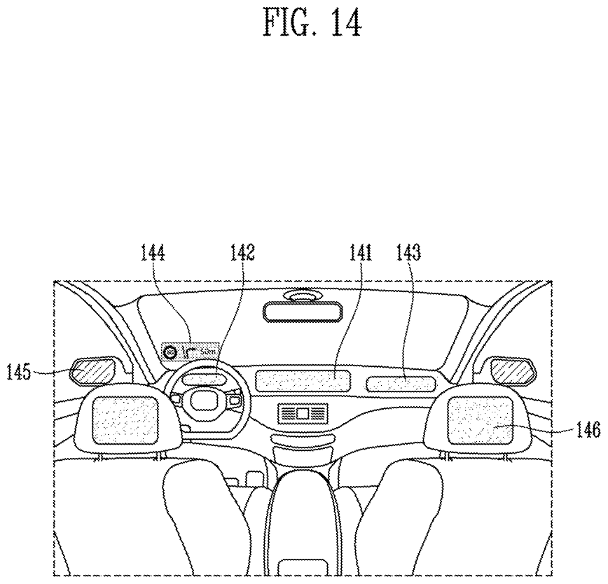

Referring to FIG. 14, the display device in accordance with the aforementioned embodiments may be applied to an automotive display. For example, the automotive display may be an electronic device which is provided inside or outside a vehicle to provide image data.

For example, the display device in accordance with the aforementioned embodiments may be applied to at least one of an infotainment panel 141, a cluster 142, a co-driver display 143, a head-up display 144, a side mirror display 145, and a rear seat display 146, which may be provided in the vehicle.

In accordance with a pixel and a display device including the pixel in accordance with embodiments of the present disclosure, the pixel may be implemented using a transistor {e.g., a metal-oxide-semiconductor field-effect transistor (MOSFET)} suitable for high resolution.

Furthermore, the pixel in accordance with embodiments of the present disclosure may include a driving transistor having a body electrode. The threshold voltage of the driving transistor may be reliably compensated for.

In addition, the pixel in accordance with embodiments of the present disclosure may transmit data signals using capacitor coupling, whereby a voltage range of the data signal may be set to a relatively large range.

However, effects of the present disclosure are not limited to the above-described effects, and various modifications are possible without departing from the spirit and scope of the present disclosure.

While embodiments of the present disclosure have been described above, those skilled in the art will appreciate that various modifications, additions and substitutions are possible, without departing from the scope and spirit of the present disclosure embodied in the appended claims.

What is claimed is:

1. A pixel comprising:
a first transistor including a first electrode electrically connected to a first power line configured to receive first driving power, a second electrode, and a gate electrode connected to a first node;
a second transistor connected between a data line and the first node, and including a gate electrode electrically connected to a first scan line;
a light emitting element including a first electrode connected to the second electrode of the first transistor, and a second electrode electrically connected to a second power line configured to receive second driving power;
a first capacitor connected between the first node and the first electrode of the light emitting element; and
a second capacitor connected between the first electrode of the light emitting element and a third power line.

2. The pixel according to claim 1, wherein a ratio of a capacitance of the second capacitor to a capacitance of the first capacitor is at least 0.1.

3. The pixel according to claim 1, wherein the second driving power is a voltage lower than the first driving power.

4. The pixel according to claim 1, wherein the third power line receives first initialization power having a voltage value at which the light emitting element is turned off in response to receiving the first initialization power at the first electrode of the light emitting element.

5. The pixel according to claim 4, wherein the first initialization power is ground power.

6. The pixel according to claim 1, further comprising:
a third transistor connected between the first electrode of the light emitting element and the third power line, and including a gate electrode electrically connected to a second scan line;
a third capacitor including a first electrode, and a second electrode connected to the first node; and
a fourth transistor including a first electrode electrically connected to a fourth power line, a second electrode connected to the first electrode of the third capacitor, and a gate electrode electrically connected to a third scan line.

7. The pixel according to claim 6, wherein each of the first, second, third, and fourth transistors comprises a metal-oxide-semiconductor field-effect transistor (MOSFET) including a body electrode.

8. The pixel according to claim 7, wherein the first driving power is supplied to the body electrode of each of the first, second, third, and fourth transistors.

9. The pixel according to claim 6, wherein the third scan line comprises a scan line identical to the second scan line.

10. The pixel according to claim 6,
wherein the horizontal period comprises a first period, a second period, and a third period, and
wherein, during the first period and the second period, a voltage of reference power is supplied to the data line, and during the third period, a voltage of a data signal is supplied to the data line.

11. The pixel according to claim 10, wherein the reference power is a voltage value between the first driving power and the second driving power.

12. The pixel according to claim 10, wherein second initialization power is supplied to the fourth power line, and the reference power has a voltage that is equal to a voltage of the second initialization power.

13. The pixel according to claim 10,
wherein, during the first period, the second transistor, the third transistor, and the fourth transistor are turned on, and
wherein, during the second period and the third period, the second transistor is turned on, and the third transistor and the fourth transistor are turned off.

14. A display device, comprising:
pixels connected to first scan lines, second scan lines, third scan lines, and data lines,
wherein, among the pixels, a pixel positioned on an i-th pixel row (i is an integer of 0 or more) and a j-th pixel column (j is an integer of 0 or more) comprises:
a first transistor including a first electrode electrically connected to a first power line configured to receive first driving power, a second electrode, and a gate electrode connected to a first node;
a second transistor connected between a j-th data line and the first node, and configured to be turned on when a first scan signal is supplied to an i-th first scan line;
a light emitting element including a first electrode connected to the second electrode of the first transistor, and a second electrode electrically connected to a second power line configured to receive second driving power;
a first capacitor connected between the first node and the first electrode of the light emitting element; and
a second capacitor connected between the first electrode of the light emitting element and a third power line configured to receive first initialization power.

15. The display device according to claim 14, wherein a ratio of a capacitance of the second capacitor to a capacitance of the first capacitor is at least 0.1.

16. The display device according to claim 14, wherein the pixel positioned on the i-th pixel row and the j-th pixel column further comprises:
a third transistor connected between the first electrode of the light emitting element and the third power line, and configured to be turned on when a second scan signal is supplied to an i-th second scan line;
a third capacitor including a first electrode, and a second electrode connected to the first node; and
a fourth transistor including a first electrode electrically connected to a fourth power line configured to receive second initialization power, and a second electrode connected to the first electrode of the third capacitor, the fourth transistor being configured to be turned on when a third scan signal is supplied to an i-th third scan line.

17. The display device according to claim 16,
wherein each of the first, second, third, and fourth transistors comprises a metal-oxide-semiconductor field-effect transistor (MOSFET) including a body electrode, and
wherein the first driving power is supplied to the body electrode of each of the first, second, third, and fourth transistors.

18. The display device according to claim 16, wherein a horizontal period in which the pixel positioned on the i-th pixel row and the j-th pixel column is driven includes a first period, a second period, and a third period, the display device further comprising:
a data driver configured to supply a voltage of reference power to the j-th data line during the first period and the second period, and supply a voltage of a data signal to the j-th data line during the third period;
a first scan driver configured to supply the first scan signal to the i-th first scan line during the first to the third periods;
a second scan driver configured to supply the second scan signal to the i-th second scan line during the first period; and
a third scan driver configured to supply the third scan signal to the i-th third scan line during the first period.

19. The display device according to claim 18,
wherein the reference power is equal to the second initialization power having a voltage between the first driving power and the second driving power.

20. The display device according to claim 18, wherein the third scan line is a scan line identical to the second scan line, and the third scan driver is a driver identical to the second scan driver.
